(19) United States
(12) Patent Application Publication
(10) Pub. No.: US 2024/0387102 A1
(43) Pub. Date: Nov. 21, 2024

(54) INDUCTOR MODULE AND MANUFACTURING METHOD THEREOF

(71) Applicant: SILICONWARE PRECISION INDUSTRIES CO., LTD., Taichung City (TW)

(72) Inventors: Huei-Chi YANG, Taichung City (TW); Tai-Tsung HSU, Taichung City (TW); Ho-Chuan LIN, Taichung City (TW)

(73) Assignee: SILICONWARE PRECISION INDUSTRIES CO., LTD., Taichung City (TW)

(21) Appl. No.: 18/366,892

(22) Filed: Aug. 8, 2023

(30) Foreign Application Priority Data
May 16, 2023 (TW) 112118163

(51) Int. Cl. H01F 41/04; H01F 17/00; H01F 27/02; H01F 27/28

(52) U.S. Cl. CPC H01F 41/041; H01F 17/0013; H01F 27/022; H01F 27/2823

(57) ABSTRACT

An inductor module is provided, in which a first coil and a second coil surrounding an outer circumference of the first coil are formed on a carrier structure to generate magnetic flux. The first coil includes a first conductive layer bonded to the carrier structure, and a plurality of first wires arranged on the carrier structure and connected to the first conductive layer. The second coil includes a second conductive layer bonded to the carrier structure, a plurality of conductive pillars embedded in the carrier structure and connected to the second conductive layer, and a plurality of second wires arranged on the carrier structure and connected to the conductive pillars. The first conductive layer and the second conductive layer are arranged at intervals in different layers of the carrier structure.

### BACKGROUND

### 1. Technical Field

The present disclosure relates to a passive module, and more particularly, to an inductor module capable of increasing inductance value and a manufacturing method thereof.

### 2. Description of Related Art

In general semiconductor application devices such as communication or high-frequency semiconductor devices, radio-frequency passive components such as resistors, inductors, capacitors and oscillators are often required to be electrically connected to the packaged semiconductor chip, so that the semiconductor chip has specific current characteristics or can transmit signals.

For example, in a semiconductor device with a ball grid array (BGA), although most passive components are placed on the surface of a substrate, these passive components are mostly and conventionally placed on corners of the substrate or on additional layout area of the substrate outside the semiconductor chip mounting area in order to prevent these passive components from hindering electrical connections and arrangements between the semiconductor chip and most solder pads.

However, restricting the positions of the passive components will limit the flexibility of the substrate circuit routability and needs to take into account that the positions of the solder pads may limit the arrangement amount of these passive components, which is unconducive to the development trend of high integration of the semiconductor devices. Further, the arrangement amount of the passive components may increase relatively rapidly with the high performance requirements of the semiconductor packages. For instance, in the conventional method, the surface of the substrate must accommodate many semiconductor chips and more passive components at the same time, resulting in an increase in the area of the package substrate and in an increase in the volume of the package, thereby not meeting the development trend of semiconductor package being thin, light and small.

Based on the above problems, many passive components in the industry are made as integrated components (such as chip-type inductors) and integrated on the substrate area between a semiconductor chip and solder pad areas. For instance, as shown in a semiconductor package 1 of FIG. 1, a semiconductor chip 11 and a coil-type inductor 12 are disposed on a package substrate 10 with a circuit layer 100, and the semiconductor chip 11 is electrically connected to bonding pads 101 of the circuit layer 100 via a plurality of bonding wires 110.

However, in the conventional semiconductor package 1, the coil-type inductor 12 is merely arranged on the package substrate 10, thereby the inductance analog value generated by the coil-type inductor 12 is limited, so that the inductance value of the coil-type inductor 12 is too small to meet the requirements.

Moreover, the coil-type inductor 12 occupies too much surface area of the package substrate 10, so that the volume of the semiconductor package 1 is difficult to reduce, thereby not meeting the requirement of miniaturization.

Therefore, how to overcome the problems of the above-mentioned prior art has become an urgent problem to be solved at present.

### SUMMARY

In view of the aforementioned shortcomings of the prior art, the present disclosure provides an inductor module, which comprises: a carrier structure; a first coil comprising a first conductive layer bonded to the carrier structure and a plurality of first wires arranged on the carrier structure and connected to the first conductive layer; a second coil surrounding an outer circumference of the first coil and comprising a second conductive layer bonded to the carrier structure, a plurality of conductive pillars embedded in the carrier structure and connected to the second conductive layer and a plurality of second wires arranged on the carrier structure and connected to the conductive pillars, wherein the first conductive layer and the second conductive layer are arranged at intervals in different layers of the carrier structure; and an encapsulating layer formed on the carrier structure and covering the first wires and the second wires.

The present disclosure also provides a method of manufacturing an inductor module, the method comprises: providing a carrier structure comprising a first conductive layer, a second conductive layer and a plurality of conductive pillars connected to the second conductive layer, wherein the first conductive layer and the second conductive layer are arranged at intervals in different layers; forming a plurality of first wires on the carrier structure, wherein the first wires are connected to the first conductive layer to form a first coil; forming a plurality of second wires on the carrier structure, wherein the second wires are connected to the conductive pillars to form a second coil surrounding an outer circumference of the first coil; and forming an encapsulating layer on the carrier structure to cover the first wires and the second wires.

In the aforementioned inductor module and method, the first conductive layer comprises a plurality of first wire bodies arranged at intervals, and two opposite wire ends of part of the first wires are respectively connected to different ends of two adjacent ones of the plurality of first wire bodies. Further, the present disclosure further comprises forming a transfer wire and a plurality of contacts that are spaced apart from the first wire bodies and arranged at two opposite edges of the first conductive layer in the carrier structure. For instance, at one edge of the first conductive layer, two opposite wire ends of one of the first wires are connected to one of the contacts and one of the first wire bodies respectively, wherein at another edge of the first conductive layer, two opposite wire ends of another one of the first wires are connected to another one of the first wire bodies and the transfer wire respectively. Alternatively, at one edge of the second conductive layer, two opposite wire ends of one of the second wires are connected to the transfer wire and one of the conductive pillars on the second conductive layer respectively, wherein at another edge of the second conductive layer, two opposite wire ends of another one of the second wires are connected to another one of the conductive pillars on the second conductive layer and another one of the contacts respectively.

In the aforementioned inductor module and method, the second conductive layer comprises a plurality of second wire bodies arranged at intervals, and two opposite wire ends of part of the second wires are respectively connected to different ends of two adjacent ones of the plurality of second wire bodies.

In the aforementioned inductor module and method, the first wires are bonding wires used in a wire-bonding process.

In the aforementioned inductor module and method, the second wires are bonding wires used in a wire-bonding process.

In the aforementioned inductor module and method, the encapsulating layer comprises magnetic materials.

In the aforementioned inductor module and method, the carrier structure further comprises a third conductive layer and a plurality of further conductive pillars connected to the third conductive layer, and the third conductive layer and the second conductive layer are arranged at intervals in different layers, so that the second conductive layer is located between the first conductive layer and the third conductive layer, and a plurality of third wires are formed on the carrier structure and connected to the further conductive pillars to form a third coil surrounding an outer circumference of the second coil.

It can be seen from the above, in the inductor module and the manufacturing method thereof of the present disclosure, the second coil surrounds the outer circumference of the first coil to form a three-dimensional coil-type inductor, so that magnetic flux is generated between the first coil and the second coil. Hence, compared to the prior art, the inductor module of the present disclosure can effectively increase magnetic flux, thereby increasing the inductance, so that the inductance value of the inductor module of the present disclosure can be greatly increased.

In addition, the first wires and the second wires only contact the surface of the carrier structure with their bonding-wire ends, so that the surface area of the carrier structure is not occupied much by the first coil and the second coil. Hence, compared to the prior art, the volume of the inductor module or the electronic package for related application of the present disclosure can be reduced according to requirements, thereby meeting the requirement of miniaturization.

### BRIEF DESCRIPTION OF THE DRAWINGS

FIG. 1 is a schematic cross-sectional view showing a conventional semiconductor package.

FIG. 2A-1, FIG. 2B-1, FIG. 2C-1 and FIG. 2D-1 are schematic cross-sectional views illustrating a method of manufacturing an inductor module according to the present disclosure.

FIG. 2A-2 is a schematic perspective view of FIG. 2A-1.

FIG. 2B-2, FIG. 2B-3 and FIG. 2B-4 are schematic perspective views showing manufacturing process of FIG. 2B-1.

FIG. 2C-2 to FIG. 2C-3 are schematic perspective views showing manufacturing process of FIG. 2C-1.

FIG. 2C-4 is a schematic perspective view of another angle of view of FIG. 2C-3.

FIG. 2D-2 and FIG. 2D-3 are schematic perspective views of different angles of view of FIG. 2D-1.

FIG. 3A is a schematic cross-sectional view illustrating an inductor module according to another embodiment of the present disclosure.

FIG. 3B is a schematic perspective view of FIG. 3A.

### DETAILED DESCRIPTION

The following describes the implementation of the present disclosure with examples. Those skilled in the art can easily understand other advantages and effects of the present disclosure from the contents disclosed in this specification.

It should be understood that, the structures, ratios, sizes, and the like in the accompanying figures are used for illustrative purposes to facilitate the perusal and comprehension of the contents disclosed in the present specification by one skilled in the art, rather than to limit the conditions for practicing the present disclosure. Any modification of the structures, alteration of the ratio relationships, or adjustment of the sizes without affecting the possible effects and achievable proposes should still be deemed as falling within the scope defined by the technical contents disclosed in the present specification. Meanwhile, terms such as “on,” “first,” “second,” “third,” “one,” “a,” and the like used herein are merely used for clear explanation rather than limiting the practicable scope of the present disclosure, and thus, alterations or adjustments of the relative relationships thereof without essentially altering the technical contents should still be considered in the practicable scope of the present disclosure.

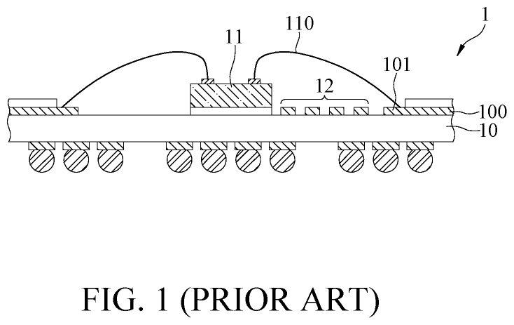

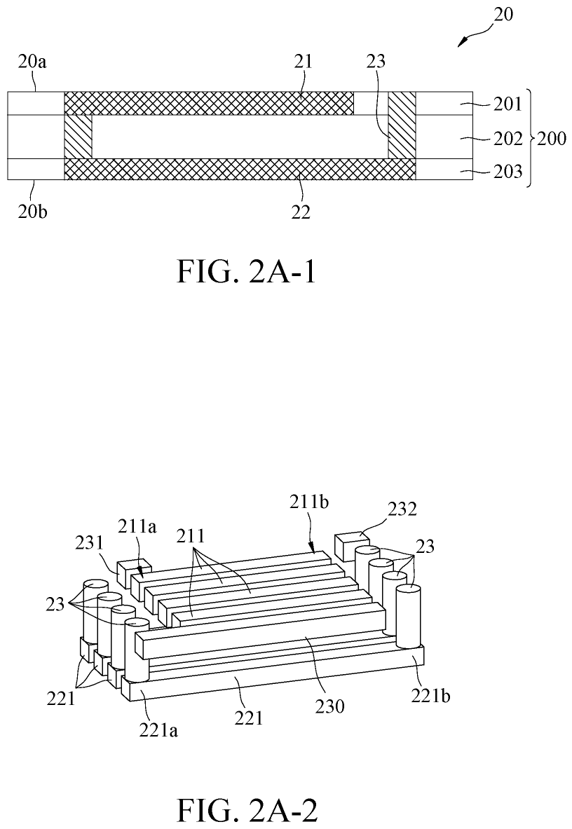

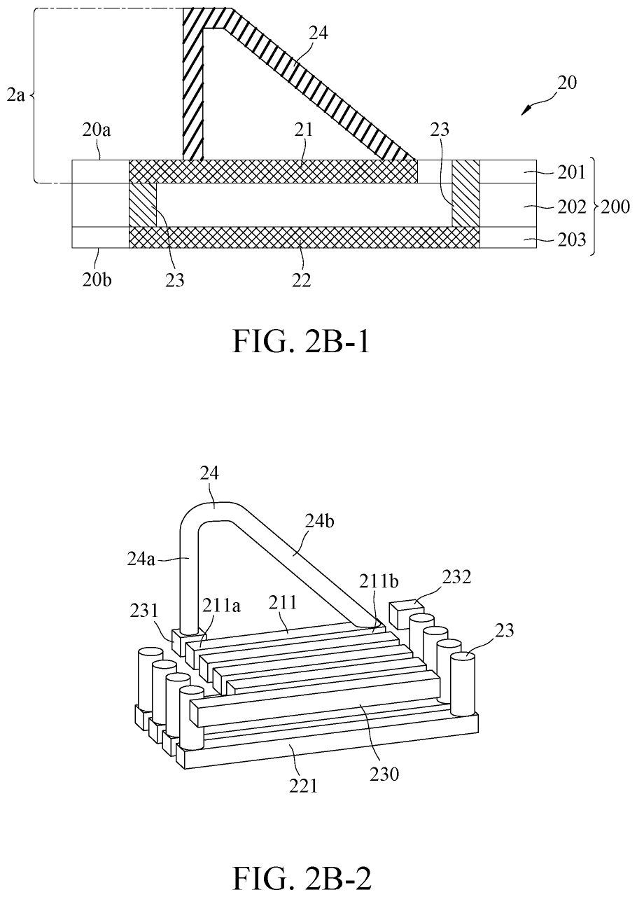

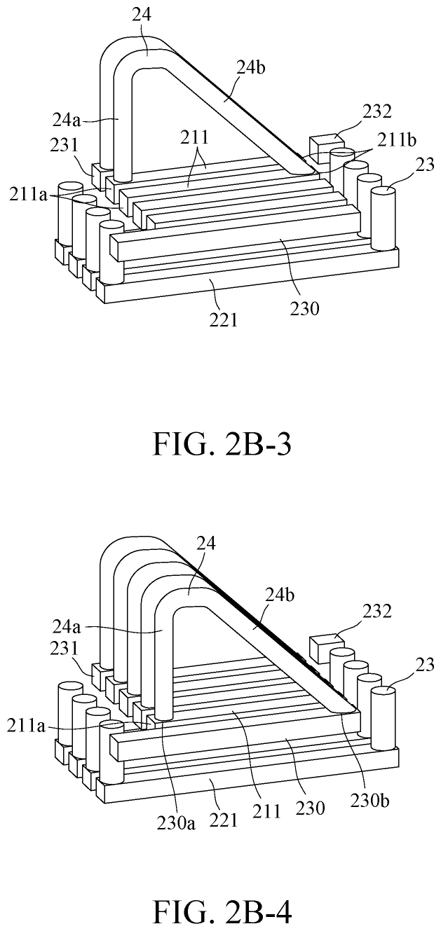

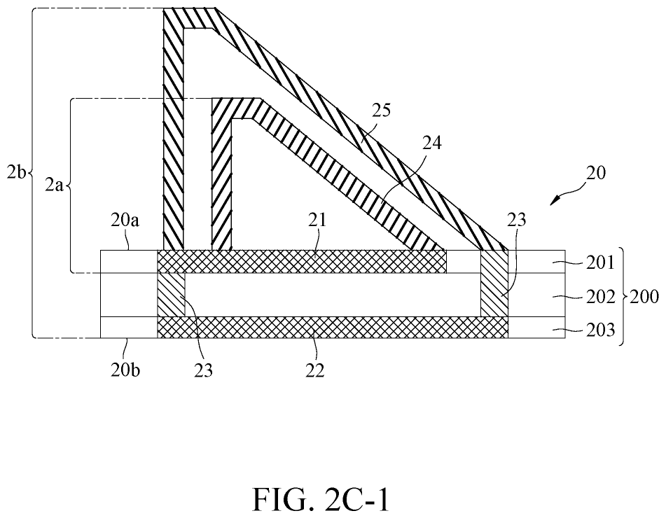

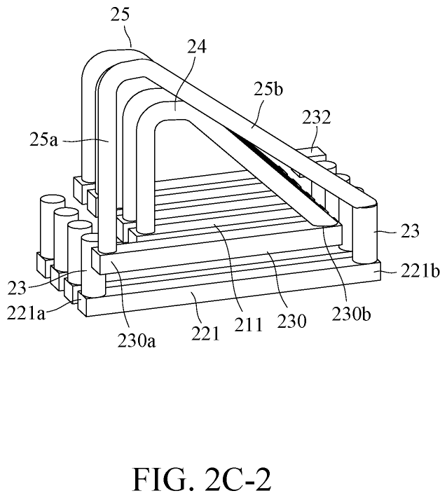

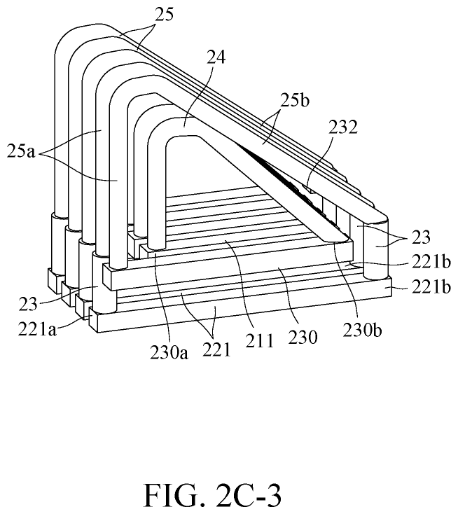

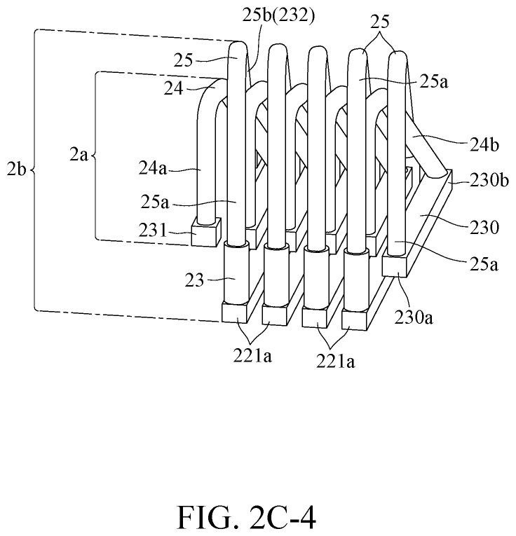

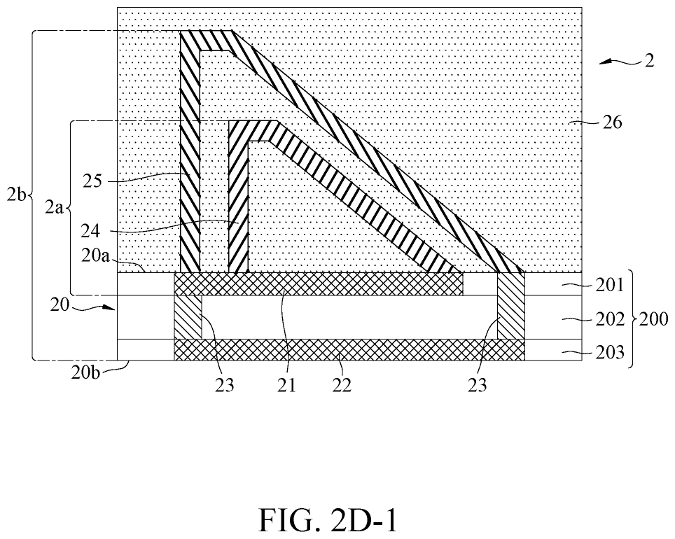

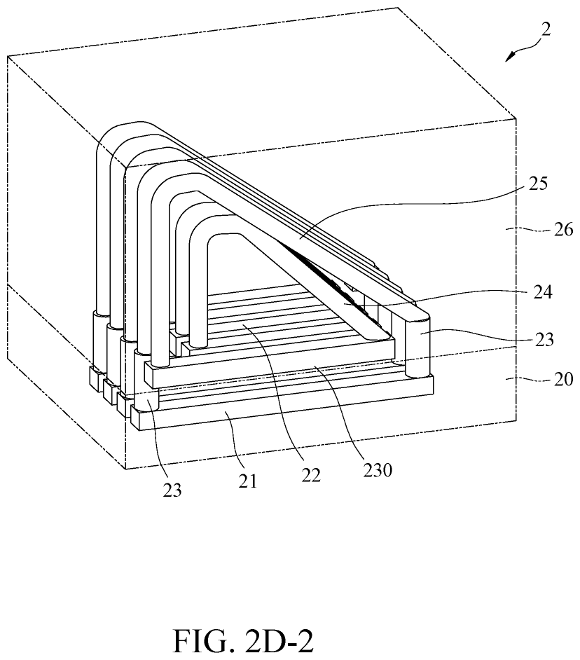

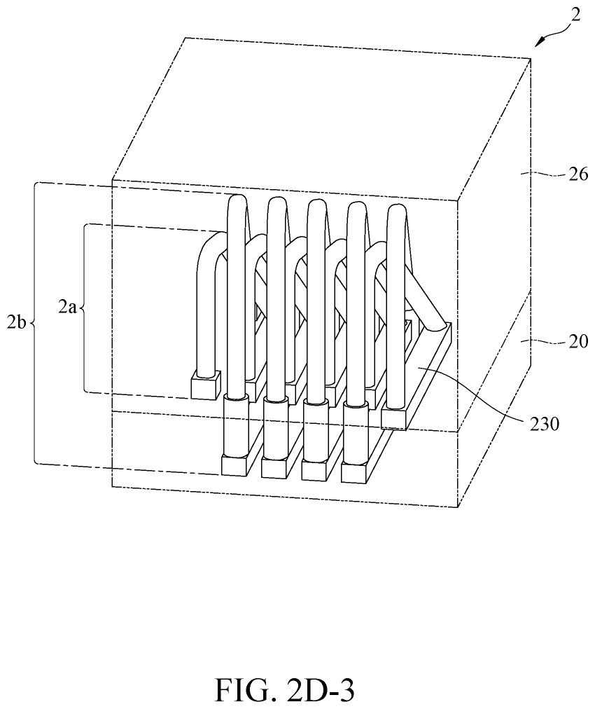

FIG. 2A-1, FIG. 2B-1, FIG. 2C-1 and FIG. 2D-1 are schematic cross-sectional views illustrating a method of manufacturing an inductor module 2 according to the present disclosure.

As shown in FIG. 2A-1, a carrier structure 20 is provided and has a first conductive layer 21, a second conductive layer 22 and a plurality of conductive pillars 23 electrically connected to the second conductive layer 22.

In an embodiment, the carrier structure 20 is a package substrate such as in a coreless form or with a core layer form, and the carrier structure 20 comprises a dielectric body 200 with a plurality of dielectric layers 201, 202, 203 and at least one circuit layer (not shown) formed on the plurality of dielectric layers 201, 202, 203, such as a fan-out type redistribution layer (RDL), and the dielectric layers 201, 202, 203 are made of polybenzoxazole (PBO), polyimide (PI), prepreg (PP), or other dielectric materials. For instance, the first conductive layer 21, the second conductive layer 22 and the conductive pillars 23 can be fabricated on the dielectric layers 201, 202, 203 together with the circuit layer, so that the first conductive layer 21 and the second conductive layer 22 are respectively arranged at intervals on different dielectric layers 201, 203, and the conductive pillars 23 are in communication with multi-layer dielectric layers 201, 202.

Moreover, the carrier structure 20 has a first side 20a and a second side 20b opposing the first side 20a, wherein the first conductive layer 21 is embedded in the dielectric layer 201 on the first side 20a and exposed from the first side 20a of the carrier structure 20, and the second conductive layer 22 is embedded in the dielectric layer 203 away from the first side 20a, and the conductive pillars 23 are in communication with the dielectric layer 201 on the first side 20a and exposed from the first side 20a of the carrier structure 20. For instance, the second conductive layer 22 is embedded in the dielectric layer 203 on the second side 20b and exposed from the second side 20b of the carrier structure 20. It should be understood that the present disclosure is not limited to the above, as long as the second conductive layer 22 is positioned in the dielectric layer 203 away from the first side 20a and not in contact with the first conductive layer 21.

Furthermore, the first conductive layer 21 comprises a plurality of first wire bodies 211 arranged at intervals, such as four first wire bodies 211 shown in FIG. 2A-2, and the second conductive layer 22 comprises a plurality of second wire bodies 221 arranged at intervals, such as four second wire bodies 221 shown in FIG. 2A-2, and a transfer wire 230 and a plurality of contacts (e.g., a first contact 231 and a second contact 232) are respectively arranged in parallel with and spaced apart from the first wire bodies 211 at two opposite edges of the first conductive layer 21 in the dielectric layer 201 on the first side 20a, such that the plurality of contacts (e.g., the first contact 231 and the second contact 232) are respectively positioned at two opposite ends 211a, 211b of the first wire body 211, and the transfer wire 230 and the plurality of contacts (e.g., the first contact 231 and the second contact 232) are exposed from the first side 20a of the carrier structure 20.

In addition, the conductive pillars 23 are in contact with the second conductive layer 22 but not in contact with the first conductive layer 21, as shown in FIG. 2A-2. For instance, the conductive pillars 23 are disposed at opposite ends 221a, 221b of the second wire bodies 221, such as eight conductive pillars 23 shown in FIG. 2A-2.

As shown in FIG. 2B-1, a plurality of first wires 24 are formed on the first side 20a of the carrier structure 20, and the plurality of first wires 24 are electrically connected to the first conductive layer 21, so that the first conductive layer 21 and the first wires 24 form a first coil 2a.

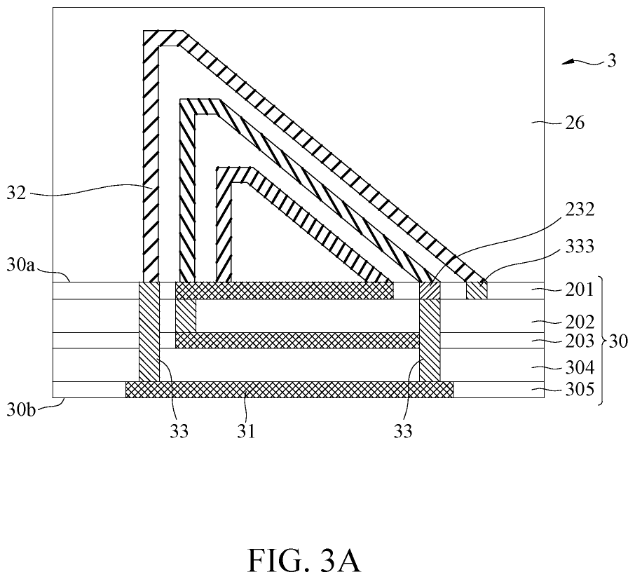

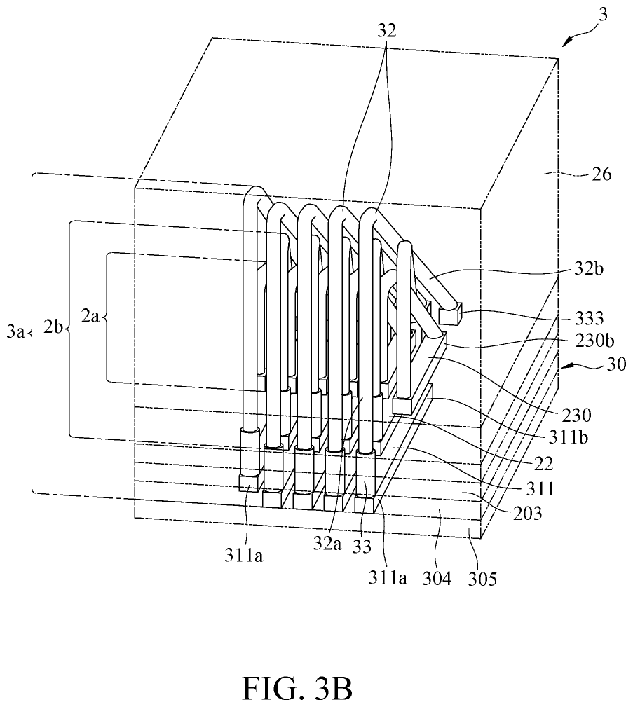

In an embodiment, each of the plurality of first wires 24 is an arc-shaped bonding wire used in a wire-bonding process (such as a gold wire or a copper wire) and correspondingly connected to each of the first wire bodies 211, such as five first wires 24 or the first coil 2a having five ring bodies shown in FIG. 2B-4. For instance, two opposite wire ends 24a, 24b of the first wire 24 are respectively connected to different ends 211a, 211b of two adjacent ones of the first wire bodies 211 (as shown in FIG. 2B-3). At one edge of the first conductive layer 21, as shown in FIG. 2B-2, two opposite wire ends 24a, 24b of the first wire 24 are connected to the first contact 231 and the end 211b of the first wire body 211 respectively. At the other edge of the first conductive layer 21, as shown in FIG. 2B-4, two opposite wire ends 24a, 24b of the first wire 24 are connected to the end 211a of the first wire body 211 and one end 230b of the transfer wire 230 respectively.

It should be understood that the first wires 24 are wired in an oblique manner, so that the vertical projection of the first wire 24 is not parallel to the first wire body 211.

As shown in FIG. 2C-1, a plurality of second wires 25 are formed on the first side 20a of the carrier structure 20, and the plurality of second wires 25 are electrically connected to the conductive pillars 23, so that the second conductive layer 22, the conductive pillars 23 and the second wires 25 form a second coil 2b surrounding the outer circumference of the first coil 2a.

In an embodiment, the plurality of second wires 25 are arc-shaped bonding wires used in a wire-bonding process (such as gold wires or copper wires) and correspondingly connected to the conductive pillar 23 on each of the second wire bodies 221, such as five second wires 25 or the second coil 2b having five ring bodies shown in FIG. 2C-3 and FIG. 2C-4. For instance, two opposite wire ends 25a, 25b of the second wire 25 are respectively connected to the conductive pillars 23 on different ends 221a, 221b of two adjacent ones of the second wire bodies 221 (as shown in FIG. 2C-3). At one edge of the second conductive layer 22, as shown in FIG. 2C-2, two opposite wire ends 25a, 25b of the second wire 25 are connected to another end 230a of the transfer wire 230 and the conductive pillar 23 on the end 221b of the second wire body 221 respectively. At the other edge of the second conductive layer 22, as shown in FIG. 2C-3 and FIG. 2C-4, two opposite wire ends 25a, 25b of the second wire 25 are connected to the conductive pillar 23 on the end 221a of the second wire body 221 and the second contact 232 respectively.

It should be understood that the second wires 25 are wired in an oblique manner, so that the vertical projection of the second wire 25 is not parallel to the second wire body 221, and the oblique direction of the second wire 25 and the oblique direction of the first wire 24 are different.

Additionally, the second coil 2b surrounds the first coil 2a, thus the first coil 2a can be regarded as an inner coil, and the second coil 2b can be regarded as an outer coil.

As shown in FIG. 2D-1, an encapsulating layer 26 is formed on the first side 20a of the carrier structure 20 to encapsulate the first wires 24 and the second wires 25.

In an embodiment, the material for forming the encapsulating layer 26 is such as polyimide (PI), dry film, epoxy resin, or molding compound. For instance, the encapsulating layer 26 can be formed on the first side 20a of the carrier structure 20 by liquid compound, injection, lamination, or compression molding, etc.

Moreover, the encapsulating layer 26 comprises magnetic materials such as magnetic powder to improve magnetic permeability. For instance, ferrite is ground into powder, then mixed into epoxy resin and stirred to fabricate the encapsulating layer 26.

Furthermore, at least one electronic component (not shown) electrically connected to the circuit layer and the first conductive layer 21 (and/or the second conductive layer 22) can be arranged on the first side 20a of the carrier structure 20 according to requirements to form an electronic package. Further, a plurality of conductive components (not shown, such as solder balls) electrically connected to the circuit layer can be disposed on the second side 20b of the carrier structure 20, so that the electronic package can be connected to an electronic device (not shown) such as a circuit board via the conductive components. For instance, the electronic component can be a semiconductor chip, which can be electrically connected to the circuit layer of the carrier structure 20 in a flip-chip, wire-bonding, or embedded manner according to requirements.

Therefore, in the manufacturing method of the present disclosure, a plurality of coil structures surrounding with each other (the second coil 2b surrounds the outer circumference of the first coil 2a) are formed on the carrier structure 20 to form a three-dimensional coil-type inductor, so that the first coil 2a is used as a hollow core (or coreless) magnetic conductor, such that magnetic flux is generated by the magnetic conductor and the second coil 2b. Hence, compared to the prior art, the inductor module 2 of the present disclosure can effectively increase magnetic flux, thereby increasing the inductance, so that the inductance value of the inductor module 2 of the present disclosure can be greatly increased.

In addition, in the present disclosure, a material with high magnetic permeability is added to the encapsulating layer 26 to increase the magnetic flux generated by the first wires 24 and the second wires 25, thereby facilitating the increment of the inductance value.

Moreover, the first wires 24 and the second wires 25 of the present disclosure only contact the surface of the first side 20a of the carrier structure 20 with their wire ends, so that the surface area of the first side 20a of the carrier structure 20 is not occupied much by the first coil 2a and the second coil 2b. Hence, compared to the prior art, the volume of the inductor module 2 or the electronic package for related application of the present disclosure can be reduced according to requirements, thereby meeting the requirement of miniaturization.

Furthermore, the amount of external coils can be increased according to requirements to increase magnetic flux, such as a third coil 3a shown in FIG. 3A and FIG. 3B, wherein the third coil 3a surrounds the outer circumference of the second coil 2b, so that the second coil 2b is regarded as an intermediate coil, and the third coil 3a is regarded as an outer coil.

The third coil 3a comprises a third conductive layer 31, a plurality of third wires 32, and a plurality of conductive pillars 33 that are in contact with the third conductive layer 31, wherein a plurality of dielectric layers 304, 305 are arranged on a second side 30b of a carrier structure 30, so that the third conductive layer 31 is embedded in the dielectric layer 305 closest to the second side 30b, and the conductive pillars 33 are in communication with multi-layer dielectric layers 201, 202, 203, 304, such that the third wires 32 are arranged on a first side 30a of the carrier structure 30 and in contact with the conductive pillars 33.

In an embodiment, the third conductive layer 31 comprises a plurality of third wire bodies 311 arranged at intervals, and the conductive pillars 33 are arranged on opposite ends 311a, 331b of each of the third wire bodies 311, and a third contact 333 is formed in the dielectric layer 201 on the first side 30a of the carrier structure 30, such that the third contact 333 is located at one edge of the third conductive layer 31 (such as the right side shown in FIG. 3B) corresponding to the outside of the end 230b of the transfer wire 230.

Additionally, based on the third wire body 311 at the other edge (such as the left side shown in FIG. 3B) of the third conductive layer 31, the conductive pillar 33 on the one end 311b is in contact with and connected to the second contact 232, and the conductive pillar 33 on the other end 311a is in contact with and connected to the third wire 32.

Moreover, the plurality of third wires 32 are arc-shaped wires used in a wire-bonding process (such as gold wires or copper wires) and correspondingly connected to the conductive pillar 33 on each of the third wire bodies 311, such as five third wires 32 or the third coil 3a having five ring bodies shown in FIG. 3B. For instance, two opposite wire ends 32a, 32b of the third wire 32 are respectively connected to the conductive pillars 33 on different ends 311a, 311b of two adjacent ones of the third wire bodies 311 (as shown in FIG. 3B). At one edge of the third conductive layer 31 (such as the right side shown in FIG. 3B), two opposite wire ends 32a, 32b of the third wire 32 are connected to the conductive pillar 33 on the end 311a of the third wire body 311 and the third contact 333 respectively. At the other edge of the third conductive layer 31 (such as the left side shown in FIG. 3B), two opposite wire ends 32a, 32b of the third wire 32 are respectively connected to the conductive pillars 33 on different ends 311a, 311b of two adjacent ones of the third wire bodies 311.

It should be understood that the third wires 32 are wired in an oblique manner, so the vertical projection of the third wire 32 is not parallel to the third wire body 311, and the oblique direction of the third wire 32 and the oblique direction of the second wire 25 are different.

Therefore, the winding path of the third coil 3a is in the sequence of the second contact 232, the conductive pillar 33, the third wire body 311, the conductive pillar 33, the third wire 32, the conductive pillar 33, the third wire body 311, the conductive pillar 33, the third wire 32, the conductive pillar 33, . . . , the third wire body 311, the conductive pillar 33, the third wire 32 and the third contact 333.

The present disclosure further provides an inductor module 2, 3, which comprises: a carrier structure 20, 30, a first coil 2a, a second coil 2b, and an encapsulating layer 26.

The first coil 2a comprises a first conductive layer 21 bonded to the carrier structure 20, 30, and a plurality of first wires 24 disposed on the carrier structure 20, 30 and connected to the first conductive layer 21.

The second coil 2b surrounds the outer circumference of the first coil 2a and comprises a second conductive layer 22 bonded to the carrier structure 20, 30, a plurality of conductive pillars 23 embedded in the carrier structure 20, 30 and connected to the second conductive layer 22, and a plurality of second wires 25 arranged on the carrier structure 20, 30 and connected to the conductive pillars 23, wherein the first conductive layer 21 and the second conductive layer 22 are arranged at intervals in different layers.

The encapsulating layer 26 is formed on the carrier structure 20, 30 to encapsulate the first wires 24 and the second wires 25.

In an embodiment, the first conductive layer 21 comprises a plurality of first wire bodies 211 arranged at intervals, and two opposite wire ends 24a, 24b of part of the first wires 24 are respectively connected to different ends 211a, 211b of two adjacent ones of the plurality of first wire bodies 211. Further, a transfer wire 230 and first and second contacts 231, 232 spaced apart from the first wire bodies 211 are arranged at two opposite edges of the first conductive layer 21 in the carrier structure 20, 30.

For instance, at one edge of the first conductive layer 21, two opposite wire ends 24a, 24b of one first wire 24 are connected to the first contact 231 and one first wire body 211 respectively. At the other edge of the first conductive layer 21, two opposite wire ends 24a, 24b of another one first wire 24 are connected to another one first wire body 211 and the transfer wire 230 respectively.

Alternatively, at one edge of the second conductive layer 22, two opposite wire ends 25a, 25b of one second wire 25 are connected to the transfer wire 230 and one conductive pillar 23 on the second conductive layer 22 respectively. At the other edge of the second conductive layer 22, two opposite wire ends 25a, 25b of another one second wire 25 are connected to another one conductive pillar 23 on the second conductive layer 22 and the second contact 232 respectively.

In an embodiment, the second conductive layer 22 comprises a plurality of second wire bodies 221 arranged at intervals, and two opposite wire ends 25a, 25b of part of the second wires 25 are respectively connected to different ends 221a, 221b of two adjacent ones of the plurality of second wire bodies 221.

In an embodiment, the first wires 24 are bonding wires used in a wire-bonding process.

In an embodiment, the second wires 25 are bonding wires used in a wire-bonding process.

In an embodiment, the encapsulating layer 26 comprises magnetic materials.

In an embodiment, the inductor module 3 further comprises a third coil 3a surrounding an outer circumference of the second coil 2b, and the third coil 3a comprises a third conductive layer 31 bonded to the carrier structure 30, a plurality of further conductive pillars 33 embedded in the carrier structure 30 and connected to the third conductive layer 31, and a plurality of third wires 32 arranged on the carrier structure 30 and connected to the further conductive pillars 33, wherein the third conductive layer 31 and the second conductive layer 22 are arranged at intervals in different layers, so that the second conductive layer 22 is located between the first conductive layer 21 and the third conductive layer 31.

To sum up, in the inductor module and the manufacturing method thereof of the present disclosure, the second coil surrounds the outer circumference of the first coil to form a three-dimensional coil-type inductor, so that magnetic flux is generated between the first coil and the second coil. Hence, the inductor module of the present disclosure can effectively increase magnetic flux, thereby increasing the inductance, so that the inductance value of the inductor module of the present disclosure can be greatly increased.

In addition, the first wires and the second wires only contact the surface of the carrier structure with their bonding-wire ends, so that the surface area of the carrier structure is not occupied much by the first coil and the second coil. Hence, the volume of the inductor module or the electronic package for related application of the present disclosure can be reduced according to requirements, thereby meeting the requirement of miniaturization.

The above embodiments are provided for illustrating the principles of the present disclosure and its technical effect, and should not be construed as to limit the present disclosure in any way. The above embodiments can be modified by one of ordinary skill in the art without departing from the spirit and scope of the present disclosure. Therefore, the scope claimed of the present disclosure should be defined by the following claims.

What is claimed is:

1. An inductor module, comprising:
a carrier structure;
a first coil comprising a first conductive layer bonded to the carrier structure and a plurality of first wires arranged on the carrier structure and connected to the first conductive layer;
a second coil surrounding an outer circumference of the first coil and comprising a second conductive layer bonded to the carrier structure, a plurality of conductive pillars embedded in the carrier structure and connected to the second conductive layer, and a plurality of second wires arranged on the carrier structure and connected to the conductive pillars, wherein the first conductive layer and the second conductive layer are arranged at intervals in different layers of the carrier structure; and
an encapsulating layer formed on the carrier structure and covering the first wires and the second wires.

2. The inductor module of claim 1, wherein the first conductive layer comprises a plurality of first wire bodies arranged at intervals, and two opposite wire ends of part of the first wires are respectively connected to different ends of two adjacent ones of the plurality of first wire bodies.

3. The inductor module of claim 2, further comprising a transfer wire and a plurality of contacts spaced apart from the first wire bodies and arranged at two opposite edges of the first conductive layer in the carrier structure.

4. The inductor module of claim 3, wherein at one edge of the first conductive layer, two opposite wire ends of one of the first wires are connected to one of the contacts and one of the first wire bodies respectively, and at another edge of the first conductive layer, two opposite wire ends of another one of the first wires are connected to another one of the first wire bodies and the transfer wire respectively.

5. The inductor module of claim 3, wherein at one edge of the second conductive layer, two opposite wire ends of one of the second wires are connected to the transfer wire and one of the conductive pillars on the second conductive layer respectively, and at another edge of the second conductive layer, two opposite wire ends of another one of the second wires are connected to another one of the conductive pillars on the second conductive layer and another one of the contacts respectively.

6. The inductor module of claim 1, wherein the second conductive layer comprises a plurality of second wire bodies arranged at intervals, and two opposite wire ends of part of the second wires are respectively connected to different ends of two adjacent ones of the plurality of second wire bodies.

7. The inductor module of claim 1, wherein the first wires are bonding wires used in a wire-bonding process.

8. The inductor module of claim 1, wherein the second wires are bonding wires used in a wire-bonding process.

9. The inductor module of claim 1, wherein the encapsulating layer comprises magnetic materials.

10. The inductor module of claim 1, further comprising a third coil surrounding an outer circumference of the second coil, wherein the third coil comprises a third conductive layer bonded to the carrier structure, a plurality of further conductive pillars embedded in the carrier structure and connected to the third conductive layer, and a plurality of third wires arranged on the carrier structure and connected to the further conductive pillars, wherein the third conductive layer and the second conductive layer are arranged at intervals in different layers of the carrier structure, so that the second conductive layer is located between the first conductive layer and the third conductive layer.

11. A method of manufacturing an inductor module, the method comprising:
providing a carrier structure comprising a first conductive layer, a second conductive layer and a plurality of conductive pillars connected to the second conductive layer, wherein the first conductive layer and the second conductive layer are arranged at intervals in different layers;
forming a plurality of first wires on the carrier structure, wherein the first wires are connected to the first conductive layer to form a first coil;
forming a plurality of second wires on the carrier structure, wherein the second wires are connected to the conductive pillars to form a second coil surrounding an outer circumference of the first coil; and
forming an encapsulating layer on the carrier structure to cover the first wires and the second wires.

12. The method of claim 11, wherein the first conductive layer comprises a plurality of first wire bodies arranged at intervals, and two opposite wire ends of part of the first wires are respectively connected to different ends of two adjacent ones of the plurality of first wire bodies.

13. The method of claim 12, further comprising forming a transfer wire and a plurality of contacts that are spaced apart from the first wire bodies and arranged at two opposite edges of the first conductive layer in the carrier structure.

14. The method of claim 13, wherein at one edge of the first conductive layer, two opposite wire ends of one of the first wires are connected to one of the contacts and one of the first wire bodies respectively, and at another edge of the first conductive layer, two opposite wire ends of another one of the first wires are connected to another one of the first wire bodies and the transfer wire respectively.

15. The method of claim 13, wherein at one edge of the second conductive layer, two opposite wire ends of one of the second wires are connected to the transfer wire and one of the conductive pillars on the second conductive layer respectively, and at another edge of the second conductive layer, two opposite wire ends of another one of the second wires are connected to another one of the conductive pillars on the second conductive layer and another one of the contacts respectively.

16. The method of claim 11, wherein the second conductive layer comprises a plurality of second wire bodies arranged at intervals, and two opposite wire ends of part of the second wires are respectively connected to different ends of two adjacent ones of the plurality of second wire bodies.

17. The method of claim 11, wherein the first wires are bonding wires used in a wire-bonding process.

18. The method of claim 11, wherein the second wires are bonding wires used in a wire-bonding process.

19. The method of claim 11, wherein the encapsulating layer comprises magnetic materials.

20. The method of claim 11, wherein the carrier structure further comprises a third conductive layer and a plurality of further conductive pillars connected to the third conductive layer, and the third conductive layer and the second conductive layer are arranged at intervals in different layers, so that the second conductive layer is located between the first conductive layer and the third conductive layer, and third wires are formed on the carrier structure and connected to the further conductive pillars to form a third coil surrounding an outer circumference of the second coil.
